(19) United States
(12) Patent Application Publication
(10) Pub. No.: US 2014/0368755 A1
(43) Pub. Date: Dec. 18, 2014

(54) Touch panel

(71) Applicant: WINTEK CORPORATION, Taichung City (TW)

(72) Inventors: Chun-Ho Chen, Changhua County (TW); Tsung-Yu Wang, Taichung City (TW); Kuo-Chang Su, Taichung City (TW); Chih-Jung Teng, Taichung City (TW); Chi-Ming Hsieh, Taichung City (TW)

(21) Appl. No.: 14/303,595

(22) Filed: Jun. 12, 2014

(30) Foreign Application Priority Data
Jun. 13, 2013 (TW) 102120969

(51) Int. Cl. G06F 1/16

(52) U.S. Cl. CPC G06F 1/1692
USPC 349/12

(57) ABSTRACT

A touch panel includes a substrate having a light-shielding region and a light-transmission region, a first conductive pattern disposed on the substrate, and a second conductive pattern disposed on the substrate in the light-shielding region. The first conductive pattern includes a plurality of peripheral electrodes extending from the light-transmission region into the light-shielding region. Each peripheral electrode includes a connecting part disposed in the light-shielding region. Each connecting part has two first sides opposite to each other. The second conductive pattern includes a plurality of connecting electrodes, and each connecting electrode is electrically connected to and partially overlaps each connecting part. Each connecting electrode has two second sides, and the second sides are disposed between the first sides.

### BACKGROUND OF THE INVENTION

1. Field of the Invention

The present invention relates to a touch panel, and more particularly to a connection structure of a touch panel for connecting a first conductive pattern and a second conductive pattern.

2. Description of the Prior Art

Because of the intelligent characteristics of human-computer interaction, touch panels have been widely applied to the external input interfaces of many electronic products. In recent years, as the applications of electronic products have developed diversely, consumer electronics with the integration of touch sensing functions and display panels are commercialized a lot and have evolved flourishingly, for example, mobile phones, GPS navigator system, tablet PCs, PDA and laptop PCs. Traditional touch panel is used to sense the position of the finger touch through a plurality of transparent electrode series. The transparent electrode series further are connected to the driving/sensing controller through the metal conductive lines outsides the touch region. However, when the touch panel is reduced or the recognition rate of the touch panel is increased, a distance between any two of the transparent electrode series near each other is accordingly reduced. Thus, each metal conductive line is not easily aligned to each transparent electrode series, and each formed metal conductive line is easily electrically connected to two of the transparent electrode series near each other, thereby causing two of the transparent electrode series near each other to be shorted.

### SUMMARY OF THE INVENTION

It is an objective of the present invention to provide a touch panel to solve the above-mentioned short circuit between the metal conductive lines.

According to an embodiment of the present invention, a touch panel is disclosed. The touch panel includes a substrate, a first conductive pattern, and a second conductive pattern. The substrate has a light-shielding region and a light-transmission region. The first conductive pattern is disposed on the substrate, and the first conductive pattern includes a plurality of peripheral electrodes. At least some of the peripheral electrodes extend from the light-transmission region into the light-shielding region, and each peripheral electrode includes a connecting part, wherein each connecting part has two first sides opposite to each other, and the first sides of each connecting part are spaced apart a first distance. At least a part of the second conductive pattern is disposed on the substrate in the light-shielding region. The second conductive pattern includes a plurality of connecting electrodes, and each connecting electrode partially overlaps and is electrically connected to each connecting part, wherein each connecting electrode has two second sides opposite to each other, the second sides of each connecting electrode are spaced apart a second distance, and the second distance is smaller than the first distance.

According to another embodiment of the present invention, a touch panel is disclosed. The touch panel includes a substrate, a first conductive pattern, and a second conductive pattern. The substrate has a light-shielding region and a light-transmission region. The first conductive pattern is disposed on the substrate, and the first conductive pattern includes a plurality of peripheral electrodes. At least some of the peripheral electrodes extend from the light-transmission region into the light-shielding region, and each peripheral electrode includes a connecting part, wherein each connecting part has two first sides opposite to each other, and the first sides of each connecting part are spaced apart a first distance. At least a part of the second conductive pattern is disposed on the substrate in the light-shielding region. The second conductive pattern includes a plurality of connecting electrodes, and each connecting electrode partially overlaps and is electrically connected to each connecting part, wherein each connecting electrode has two second sides opposite to each other, the second sides of each connecting electrode are spaced apart a second distance larger than or equal to the first distance.

In the touch panel of the present invention, since the ends of each electrode part are disposed between the first sides of each connecting part or disposed at the same level as each first side, the second sides of each connecting electrode are disposed between the first sides of each connecting part, and the distance between each connecting electrode and the connecting part near this connecting electrode can be increased. Accordingly, a short circuit between each connecting electrode and the connecting electrode near this connecting electrode caused from the inaccuracy in the manufacturing process can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a top view of a touch panel according to a first embodiment of the present invention.

FIG. 1B is a top view of another variant of a touch panel according to the first embodiment of the present invention.

FIG. 2 is an enlarged schematic diagram illustrating a region A in FIG. 1B.

FIG. 3 is a cross-sectional view of FIG. 2 along a cross-sectional line A-A′.

FIG. 4 is a cross-sectional view of FIG. 2 along a cross-sectional line B-B′.

FIG. 5 is an enlarged schematic diagram illustrating each connecting electrode according to the first embodiment of the present invention.

FIG. 6 is a cross-sectional view of a touch panel according to a second embodiment of the present invention.

FIG. 7 is a schematic diagram illustrating a touch panel according to a third embodiment of the present invention.

FIG. 8 is a schematic diagram illustrating a touch panel according to a fourth embodiment of the present invention.

FIG. 9 is a schematic diagram illustrating a touch panel according to a fifth embodiment of the present invention.

FIG. 10 is a schematic diagram illustrating a touch panel according to a sixth embodiment of the present invention.

FIG. 11 is a cross-sectional view of a touch panel according to a seventh embodiment of the present invention.

FIG. 12 is a flow chart of a method for manufacturing the touch panel according to the seventh embodiment of the present invention.

FIG. 13 is a schematic diagram illustrating the decoration unit according to the seventh embodiment of the present invention.

FIG. 14 is a variant of the decoration unit according to the seventh embodiment of the present invention.

FIG. 15 is a schematic diagram illustrating the decoration unit according to the eighth embodiment of the present invention.

FIG. 16 is a cross-sectional view of a touch panel according to a ninth embodiment of the present invention.

FIG. 17 is a top view of a touch panel according to a tenth embodiment of the present invention.

FIG. 18 is a cross-sectional view of FIG. 17 along a cross-sectional line C-C′.

FIG. 19 is a top view of a touch panel according to an eleventh embodiment of the present invention.

FIG. 20 is a cross-sectional view of FIG. 19 along a cross-sectional line D-D′.

FIG. 21 is a top view of a touch panel according to a twelfth embodiment of the present invention.

FIG. 22 is a cross-sectional view of FIG. 21 along a cross-sectional line E-E′.

FIG. 22A is a cross-sectional view of FIG. 21 along a cross-sectional line F-F′.

FIG. 23 is a schematic diagram illustrating a touch panel according to a thirteenth embodiment of the present invention.

FIG. 24 is a schematic diagram illustrating a touch panel according to a fourteenth embodiment of the present invention.

### DETAILED DESCRIPTION

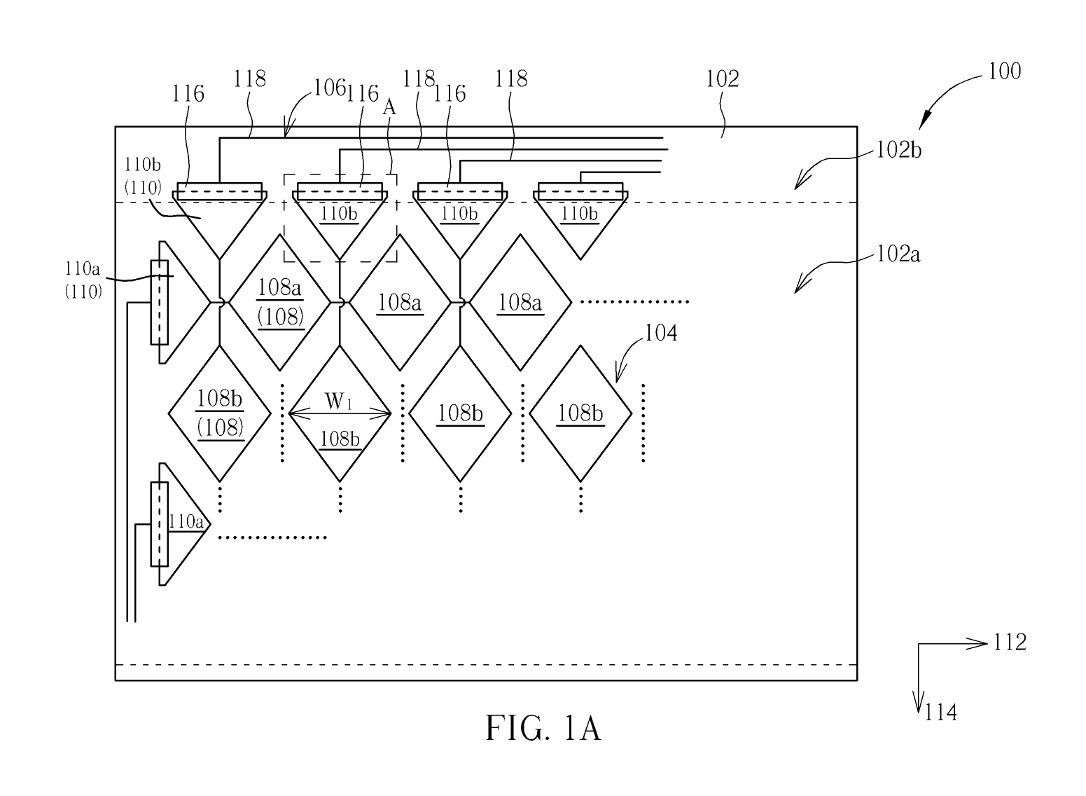

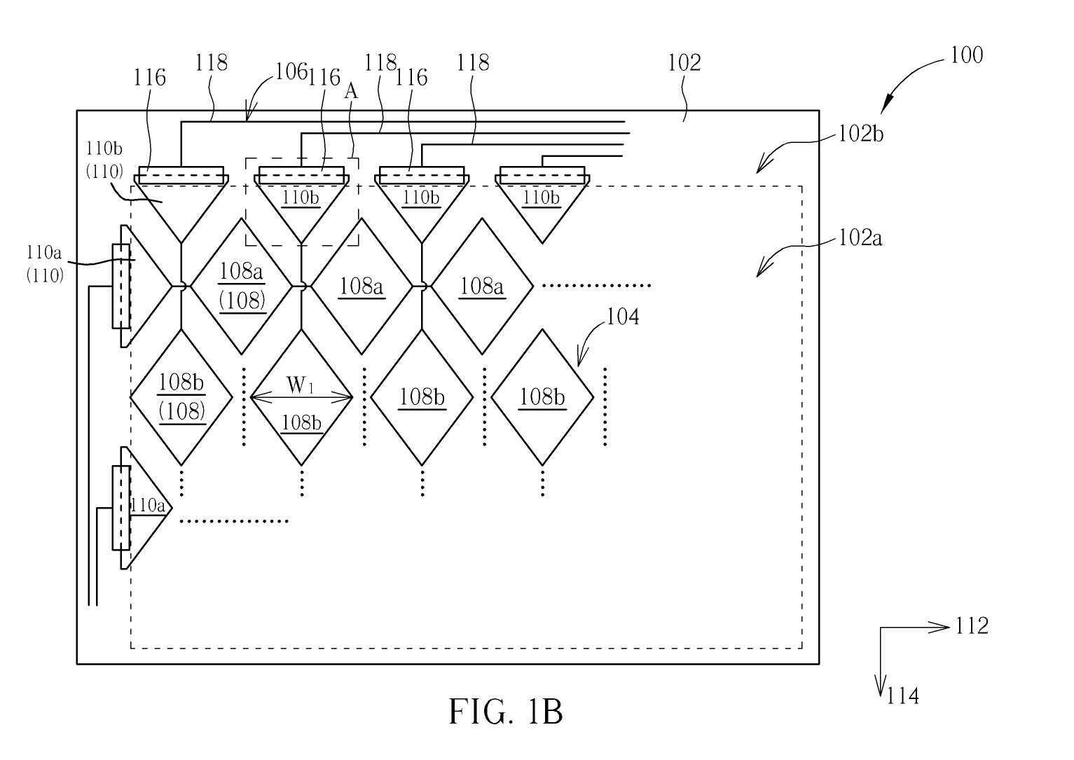

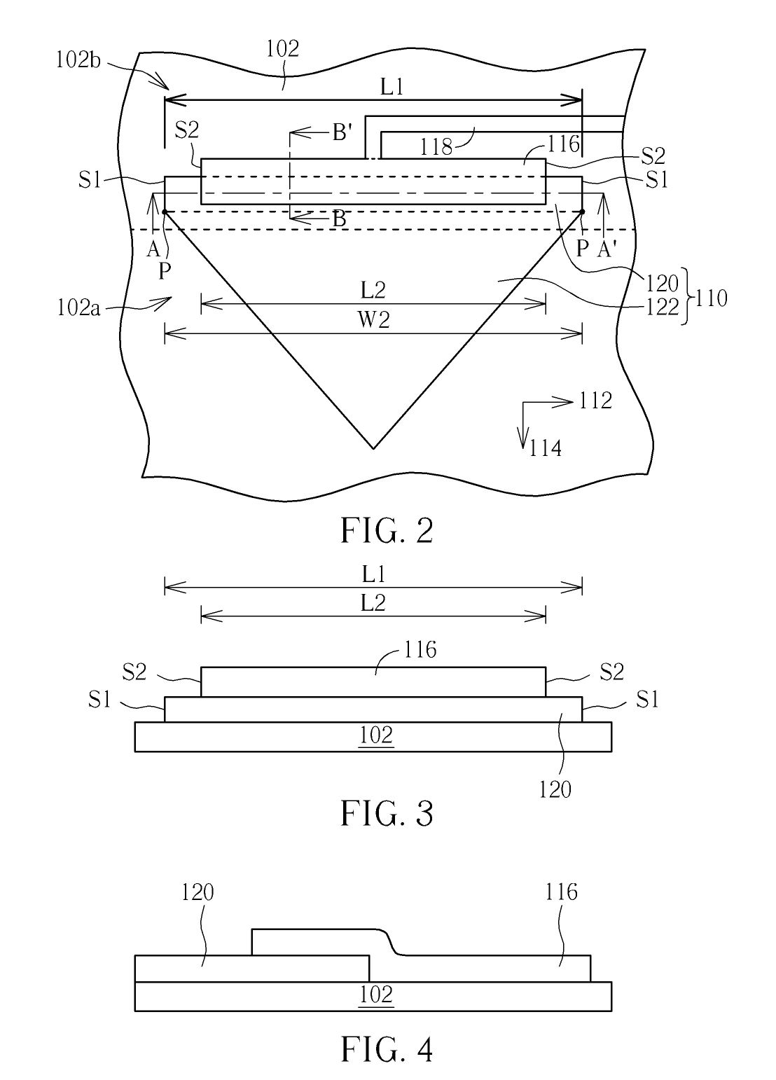

Referring to FIGS. 1A-1B and FIGS. 2-4, FIG. 1A is a top view of a touch panel according to a first embodiment of the present invention; FIG. 1B is a top view of another variant of a touch panel according to the first embodiment of the present invention; FIG. 2 is an enlarged schematic diagram illustrating a region A in FIG. 1B; FIG. 3 is a cross-sectional view of FIG. 2 along a cross-sectional line A-A′; and FIG. 4 is a cross-sectional view of FIG. 2 along a cross-sectional line B-B′. As shown in FIGS. 1A-1B, the touch panel 100 in this embodiment includes a substrate 102, a first conductive pattern 104, and a second conductive pattern 106. The substrate 102 has a light-transmission region 102a and a light-shielding region 102b. The light-shielding region 102b is disposed at at least one side of the light-transmission region 102a, as shown in FIG. 1A, but the present invention is not limited to this. The light-shielding region 102b also may surround the light-transmission region 102a, as shown in FIG. 1B. The substrate 102 may be a transparent substrate, such as glass substrate, quartz substrate or plastic substrate, but the present invention is not limited herein. For example, the substrate 102 may be a transparent cover lens, and the transparent cover lens may include glass cover lens, plastic cover lens or other cover lens formed with high mechanical strength material for protecting (such as for avoiding scraping), covering or decorating the corresponding device. A thickness of the transparent cover lens may be in a range from 0.2 mm to 2 mm. The transparent cover lens may be plane-shaped or curve-shaped, or a combination thereof, such as 2.5 D glass, but the present invention is not limited to this. Furthermore, an anti-smudge coating may be optionally disposed on a side of the transparent cover lens facing the user. The first conductive pattern 104 is disposed on the substrate 102, and at least a part of the first conductive pattern 104 may extend from the light-transmission region 102a to the light-shielding region 102b for sensing a position of an object touching or closing to the touch panel 100. The first conductive pattern 104 may include a transparent conductive material, such as carbon nanotubes, metal nanowires (such as silver nanowires or copper nanowires), conducting polymers, grapheme, silicone, indium tin oxide (ITO) or indium zinc oxide (IZO), or metal. The first conductive pattern 104 made from metal can be formed as a metal mesh pattern having a plurality of metal lines, and each of the metal lines has a line width ranging from 0.05 micrometers ˜10 micrometers. The metal mesh pattern may include an opaque metal material or a metal material having an enough thinness to allow light penetrating there through, but the present invention is not limited to this. The second conductive pattern 106 is disposed on the substrate 102 in the light-shielding region 102b, and is used to transmit a signal for driving the first conductive pattern 104 or a signal sensed by the first conductive pattern 104 to a control device, such as driving sensor chip. The second conductive pattern 106 may include metal. The second conductive pattern 106 also may be other conductive materials, for example a transparent conductive material, such as indium tin oxide, carbon nanotubes, metal nanowires (such as silver nanowires or copper nanowires), conducting polymers, grapheme or silicone, and in this case, the whole second conductive pattern 106 is not limited to be disposed on the substrate 102 in the light-shielding region 102b. That means at least a part of the second conductive pattern 106 may be disposed on the substrate 102 in the light-shielding region 102b, and the other part of the second conductive pattern 106 may be disposed in the light-transmission region 102a. In this situation, the visual feeling will not be affected by the second conductive pattern 106. In addition, the light-shielding region 102b is used to shield the second conductive pattern 106, the control device or signal transmission lines, so that the users would not see these devices. Accordingly, the area of the light-shielding region 102b may be determined by the positions of the second conductive pattern 106, the control device or the signal transmission lines. In this embodiment, the light-shielding region 102b surrounds the light-transmission region 102a, and the light-transmission region 102a and the light-shielding region 102b may be respectively disposed corresponding to a display region and a peripheral region of a display panel combined with the touch panel 100 so as to avoid the light-shielding region 102b shielding the image displayed by the display panel, but the present invention is not limited herein.

In this embodiment, the first conductive pattern 104 includes a plurality of central electrodes 108 and a plurality of peripheral electrodes 110. The central electrodes 108 are disposed in the light-transmission region 102a, and the central electrodes 108 are divided into first central electrodes 108a and second central electrodes 108b. At least some of peripheral electrodes 110 are across a boundary between the light-transmission region 102a and the light-shielding region 102b, and at least some of the peripheral electrodes 110 extend from the light-transmission region 102a to the light-shielding region 102b respectively. The at least some of the peripheral electrodes 110 may be divided into first peripheral electrodes 110a and second peripheral electrodes 110b. The first central electrodes 108a and the first peripheral electrodes 110a are arranged in a matrix, and the second central electrodes 108b and the second peripheral electrodes 110b are arranged in a matrix. Furthermore, the first central electrodes 108a and the first peripheral electrodes 110a in each column and the second central electrodes 108b and the second peripheral electrodes 110b in each column are arranged alternately in sequence. The first central electrodes 108a and the first peripheral electrodes 110a in the same row are electrically connected to one another along the first direction 112 and form a first electrode stripe. The second central electrodes 108b and the second peripheral electrodes 110b in the same column are electrically connected to one another along the second direction 114 and form a second electrode stripe. The first electrode stripes intersect and spatially insulate from the second electrode stripes. The second electrode stripes may be used to determine the position of the object touching the touch panel 100 in the first direction 112, and the first electrode stripes may be used to determine the position of the object in the second direction 114. For example, each central electrode 108 and each peripheral electrode 110 are coupled with the central electrodes 108 adjacent thereto or the peripheral electrodes 110 adjacent thereto and form a coupling capacitor, so that a total capacitance of each first electrode stripe and a total capacitance of each second electrode stripe are formed by a plurality of the coupling capacitors connected to one another. Since a capacitance of one of the coupling capacitors corresponding to a position of the touch panel 100 will be changed by the object touching the position, the variance of the total capacitance may be detect to find the position of the object. Furthermore, when the touch panel 100 in this embodiment is driven in a mutual capacitance sensing method, the control device may transmit different signals to the first electrode stripes respectively in different times, and the control device may receive the signals of the variances of the total capacitances sensed by the second electrode stripes respectively, so that the control device can sense the variances of the coupling capacitances between each first electrode stripe and each second electrode stripe adjacent to this first electrode stripe and determine the position of the object. In this case, the first electrode stripes are regarded as the electrode stripes for transmitting the signals, and the second electrode stripes are regarded as the electrode stripes for sensing the object. The present invention is not limited herein, and the first electrode stripes and the second electrode stripes may be exchanged. Also, when the touch panel 100 in this embodiment is driven in a self-capacitance sensing method to sense the position of the object, the control device determines the position of the object through detecting the variance of the total capacitance of each first electrode stripe and the variance of the total capacitance of each second electrode stripes. In this case, the first electrode stripes and the second electrode stripes are used as the electrode stripes for sensing the object. In other embodiments of the present invention, the first electrode stripes formed by the first central electrodes and the first peripheral electrodes and the second electrode stripes formed by the second central electrodes and the second peripheral electrodes may be formed on different substrates or films. Specifically, the first electrode stripes may be formed on a substrate, and the second electrode stripes may be formed on another substrate. The two substrates may be combined with an adhesive layer. Accordingly, the following connecting structure for connecting each connecting electrode to each peripheral electrode may be formed on different substrates or films since the first electrode stripes and the second electrode stripes are formed on different substrates or films.

In this embodiment, each central electrode 108 may be a rhombus, but the present invention is not limited to this shape. Each central electrode 108 has a first largest width W1 in a direction parallel to a side of the light-transmission region 102a, and the first largest width W1 is a length of a diagonal line of each central electrode 108 parallel to this direction. For example, when the direction parallel to the side of the light-transmission region 102a is first direction 112, the first largest width W1 is the length of the diagonal line of each central electrode 108 in the first direction 112. When the direction parallel to the side of the light-transmission region 102a is the second direction 114, the first largest width W1 is the length of the diagonal line of each central electrode 108 in the second direction 114. Furthermore, each peripheral electrode 110 is triangle-like. The closer to the light-shielding region 102b each peripheral electrode 110 is, the larger a width of each peripheral electrode 110 in the direction parallel to the side of the light-transmission region 102a is. The present invention is not limited to this, and the top view pattern of each central electrode and the top view pattern of each peripheral electrode in the present invention are not limited to be a rhombus and triangle-like. In other embodiments of the present invention, the top view pattern of each central electrode and the top view pattern of each peripheral electrode may be other shapes.

In addition, the second conductive pattern 106 may include a plurality of connecting electrodes 116 and a plurality of connecting lines 118. Each connecting electrode 116 and each peripheral electrode 110 are electrically connected to each other, and each connecting line 118 is connected to each connecting electrode 116 so as to electrically connect each first electrode stripe and each second electrode stripe to the control device, such as driving chip.

The structure of each connecting electrode 116 electrically connected to each peripheral electrode 110 will be further detailed in the following description. As shown in FIG. 2 through FIG. 4, at least some of the peripheral electrodes 110 respectively include a connecting part 120 and an electrode part 122. At least one part of each electrode part 122 extends from the light-transmission region 102a into the light-shielding region 102b for transmitting the signals or sensing the object. Each connecting part 120 is electrically connected to each electrode part 122 and also is electrically connected to each connecting electrode 116 respectively. Each connecting part 120 has two first sides S1 opposite to each other in the direction parallel to the side of the light-transmission region 102a, and the first sides S1 of each connecting part 120 are spaced apart a first distance L1 that is the length of each connecting part 120 in the direction. For example, regarding the second peripheral electrodes 110b, the direction parallel to the light-transmission region 102a is the first direction 112, and the direction perpendicular to the light-transmission region 102a is the second direction 114. Regarding the first peripheral electrodes 110a, the direction parallel to the side of the light-transmission region 102a is the second direction 114, and the direction perpendicular to the side of the light-transmission region 102a is the first direction 112. The following description takes the direction parallel to the side of the light-transmission region 102a being the first direction 112 and the direction perpendicular to the side of the light-transmission region 102b being the second direction 114 as an example, but the present invention is not limited herein.

Furthermore, each electrode part 122 has two ends P in the first direction 112. In this embodiment, each end P and each first side S1 are substantially disposed in a same level that is also in the second direction 114. In other words, each electrode part 122 has a second largest width W2 in the first direction 112, and the first distance L1 is substantially equal to the second largest width W2. Also, the second largest width W2 is equal to or smaller than the first largest width W1 of each central electrode 108, and the first distance L1 may be equal to or smaller than the first largest width W1.

Moreover, each connecting electrode 116 partially overlaps and is electrically connected to each connecting part 120, and each connecting electrode 116 has two second sides S2 opposite to each other in the first direction 112. The second sides S2 are spaced apart a second distance L2 that is the length of each connecting electrode 116 in the second direction 114. The second distance L2 is smaller than the first largest width W1 and the second largest width W2, so that the connecting electrodes 116 near each other are prevented from being in contact with each other. It is appreciated that the second sides S2 is disposed between the first sides S1. In other words, the first distance L1 of each connecting part 120 is larger than the second distance L2 of each connecting electrode 116. Also, a part of each connecting electrode 116 overlapping each connecting part 120 is disposed between the first sides S1, each connecting electrode 116 doesn't pass the first sides S1 of each connecting part 120. Accordingly, the distance between each connecting electrode 116 and the connecting part 120 adjacent thereto can be increased through disposing the second sides S2 of each connecting electrode 116 between the first sides S1 of each connecting part 120 in this embodiment, thereby avoiding a short circuit between each connecting electrode 116 and the connecting part 120 or the connecting electrode 116 adjacent thereto caused from the inaccuracy in the manufacturing process. Thus, the yield of manufacturing the touch panel 100 in this embodiment may be increased. In this embodiment, each connecting part 120 is disposed between each connecting electrode 116 and the substrate 102, and each connecting electrode 116 extends from each connecting part 120 onto the substrate 102. It is to be noted that each connecting line 118 is electrically connected to a part of each connecting electrode 116 without overlapping each connecting part 120. Accordingly, disconnection between each connecting line 118 and each connecting electrode 116 caused by the drop height from each connecting part 120 to the substrate 102 can be avoided.

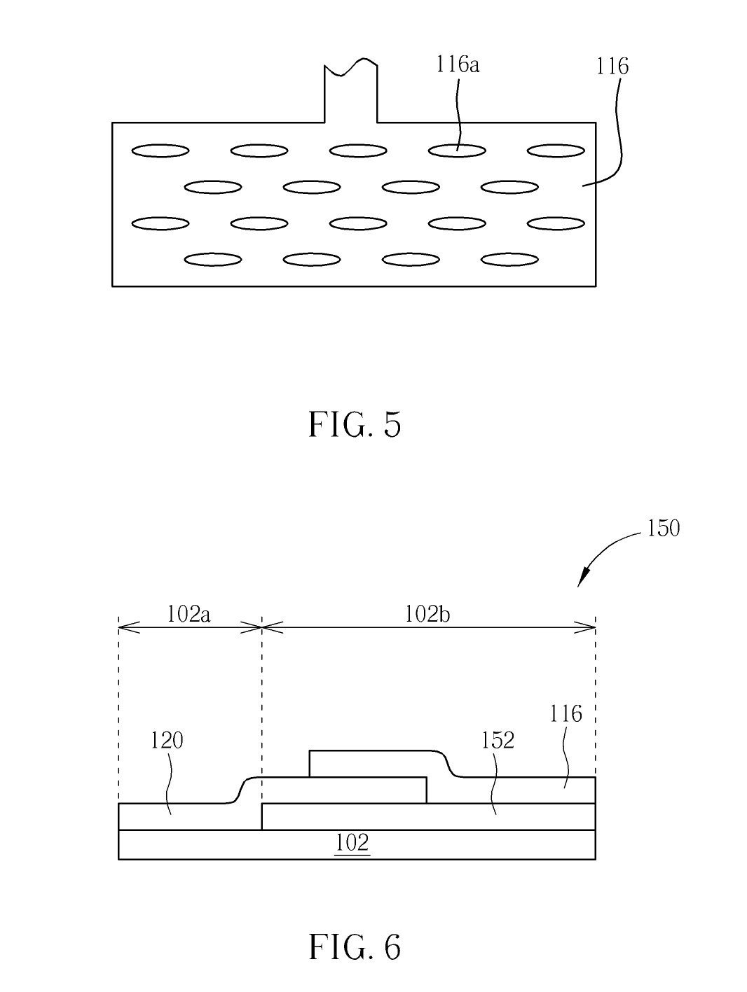

Referring to FIG. 5, FIG. 5 is an enlarged schematic diagram illustrating each connecting electrode according to the first embodiment of the present invention. As shown in FIG. 5, the connecting electrode 116 may optionally include a plurality of holes 116a, so that the tolerance of each connecting electrode for tolerate a thermal stress can be increased. In this embodiment, each hole 116a may have all kinds of shapes, such as circle, ellipse or rectangle. The arrangement of the holes 116a may be adjusted according the requirements. If the connecting electrode doesn't have the holes and have larger size, the connecting electrode easily breaks in the high temperature environment, thereby causing bad electrical connection between the connecting electrode and the connecting part. For this reason, since the connecting electrode 116 in this embodiment has the holes 116a, the tolerance of the connecting electrode 116 for the stress in high temperature can be increased, thereby avoiding breakage of the connecting electrode 116 due to having over large area. In other embodiments of the present invention, the first conductive pattern is preferably manufactured in a high temperature condition in order that the first conductive pattern may have better conductive characteristic. Accordingly, when the second conductive pattern is formed before the first conductive pattern, the connecting electrode may be prevented from breakage during forming the first conductive pattern because of having the holes.

The touch panel of the present invention is not limited to the above-mentioned embodiment. The following description continues to detail the other embodiments or modifications, and in order to simplify and show the difference between the other embodiments or modifications and the above-mentioned embodiment, the same numerals denote the same components in the following description, and the same parts are not detailed redundantly.

Referring to FIG. 6, FIG. 6 is a cross-sectional view of a touch panel according to a second embodiment of the present invention. As shown in FIG. 6, as compared with the first embodiment, the touch panel 150 in this embodiment further includes a decoration unit 152 disposed between the connecting parts 120 and the substrate 102 and between the connecting electrodes 116 and the substrate 102. That is the decoration unit 152 is formed on the substrate 102 before forming the connecting parts 120 and the connecting electrodes 116, so that the touch panel 150 in this embodiment is a SITO (Single-layer Indium Tin Oxide) structure. The decoration unit 152 is disposed in the light-shielding region 102b and used to shield the connecting electrodes 116, the control device or signal transmission lines in the light-shielding region 102b. The decoration unit 152 may include at least one decoration layer, and the decoration layer includes an insulating material, such as a ceramic material, an ink with a color, a photoresist material, diamond like carbon or resin, but the present invention is not limited herein. In other embodiments of the present invention, the first conductive pattern is preferably manufactured in a high temperature condition in order that the first conductive pattern may have better conductive characteristic, but in this case, the decoration unit is easily expanded and gas of the decoration unit is easily fled in high temperature. Although the shielding function provided by the decoration unit doesn't provide obviously influence, the decoration unit still provides stress to the second conductive pattern. Especially, when the area of the connecting electrode is larger, the opportunity of breakage of the connecting electrode is larger. Thus, the connecting electrode may optionally include a plurality of holes to reduce the tolerated thermal stress and to avoid breakage, as shown in FIG. 5.

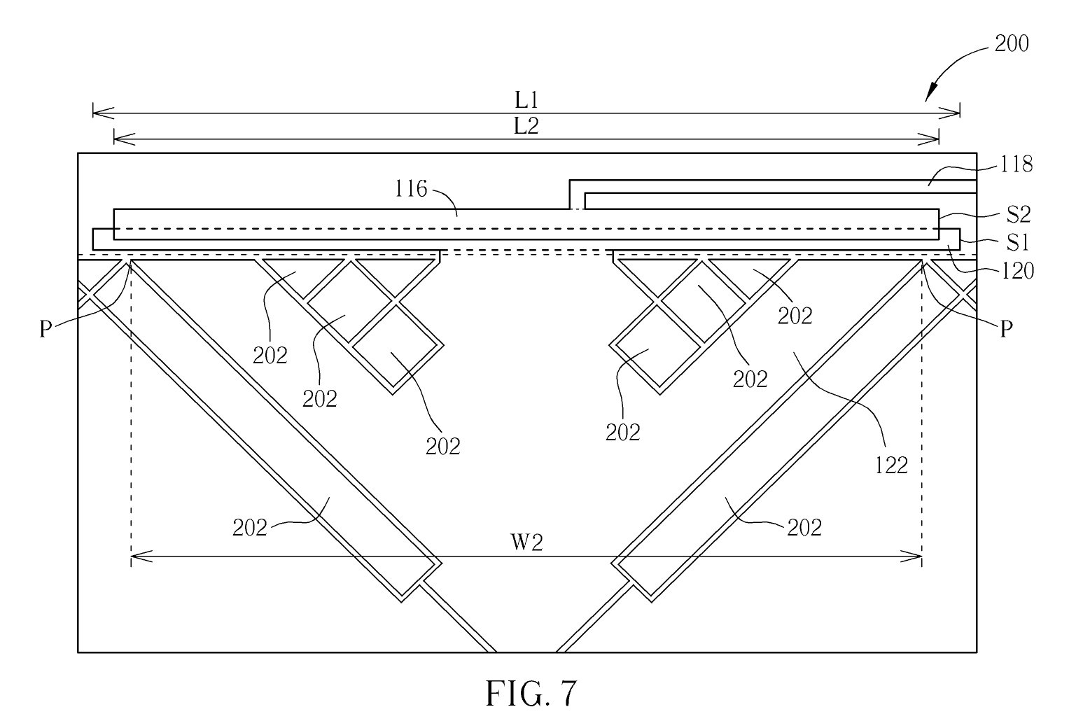

Referring to FIG. 7, FIG. 7 is a schematic diagram illustrating a touch panel according to a third embodiment of the present invention. As shown in FIG. 7, as compared with the first embodiment, the ends P of each electrode part 122 in the touch panel 200 of this embodiment are disposed between the first sides S1 of each connecting part 120. In other words, the first distance L1 is substantially larger than the second largest width W2, and the ends P of each electrode part 122 may be disposed between the second sides S2 of each connecting electrode 116, so that the second distance L2 is larger than the second largest width W2. Furthermore, the second sides S2 of each connecting electrode 116 are disposed between the first sides S1 of each connecting part 120 to avoid the short circuit between each connecting electrode 116 and the connecting part 120 or the connecting electrode 116 adjacent thereto. Also, the touch panel 200 in this embodiment further includes a plurality of dummy electrodes 202 respectively disposed between the peripheral electrodes and the central electrodes and between the connecting parts and the electrode parts 122. The present invention is not limited herein.

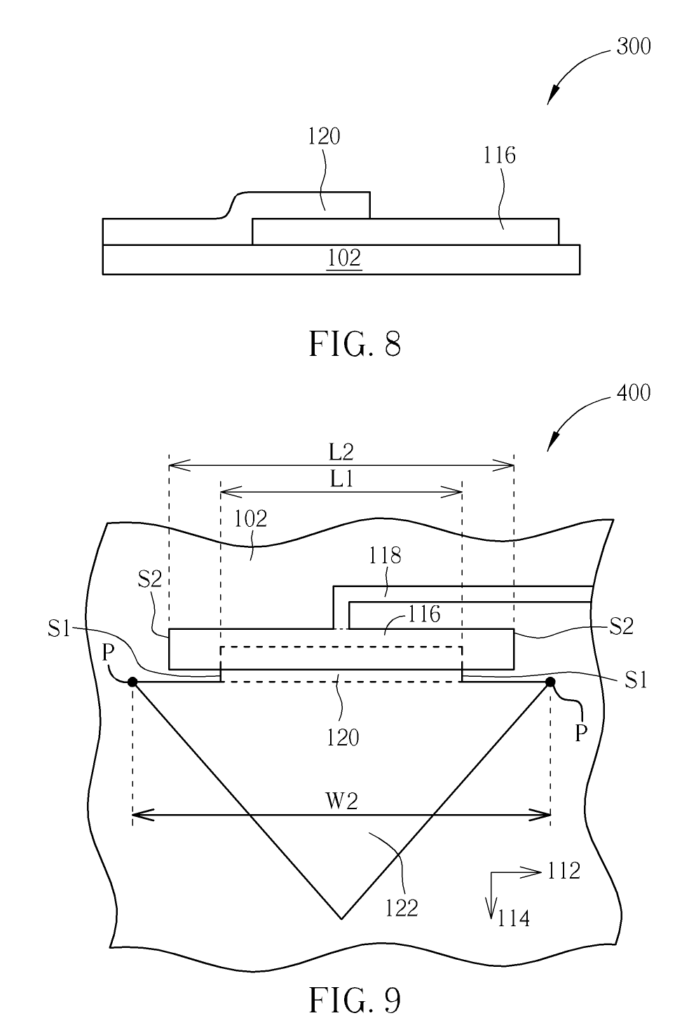

Referring to FIG. 8, FIG. 8 is a schematic diagram illustrating a touch panel according to a fourth embodiment of the present invention. As shown in FIG. 8, as compared with the first embodiment, each connecting electrode 116 of the touch panel 300 in this embodiment is disposed between each connecting part 120 and the substrate 102.

Referring to FIG. 9, FIG. 9 is a schematic diagram illustrating a touch panel according to a fifth embodiment of the present invention. As shown in FIG. 9, as compared with the first embodiment, the first sides S1 of each connecting part 120 of the touch panel 400 in this embodiment are disposed between the ends P of each electrode part 122. In other words, the first distance L1 of each connecting part 120 is smaller than the second largest width W2 of each electrode part 122, so that the first distance L1 of each connecting part 120 also can be smaller than the first largest width W1 of each central electrode 108. Furthermore, the first sides S1 of each connecting part 120 in this embodiment are disposed between the second sides S2 of each connecting electrode 116, and the second sides S2 of each connecting electrode 116 are disposed between the ends P of each electrode part 122. The first distance L1 of each connecting part 120 is smaller than the second distance L2 of each connecting electrode 116, and the second distance L2 of each connecting electrode 116 is smaller than the second largest width W2 of each electrode part 122. Accordingly, when electrostatic discharge (ESD) occurs in the touch panel 400, the electrostatic charges will flow into the connecting electrodes 116 with smaller resistance. Hence, the electrostatic charges are avoided flowing into the central electrodes 108 in the light-transmission region 102a, and the central electrodes 108 and the peripheral electrodes 110 can be avoided being damaged by the electrostatic charges. In other embodiments of the present invention, each connecting electrode may be disposed between each connecting part and the substrate.

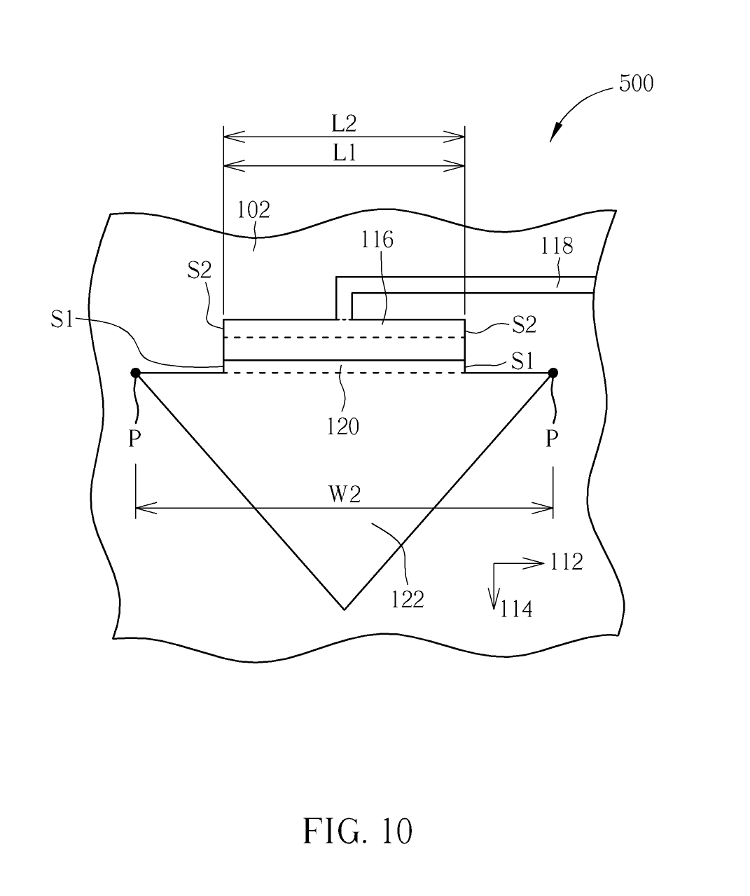

Referring to FIG. 10, FIG. 10 is a schematic diagram illustrating a touch panel according to a sixth embodiment of the present invention. As shown in FIG. 10, as compared with the fifth embodiment, each first side S1 of each connecting part 120 and each second side S2 of each connecting electrode 116 of the touch panel 500 in this embodiment may be substantially aligned and disposed in a same level. In other words, the first distance L1 of each connecting part 120 is equal to the second distance L2 of each connecting electrode 116. Also, the first distance L1 of each connecting part 120 and the second distance L2 of each connecting electrode 116 are smaller than the second largest width W2 of each electrode part 122.

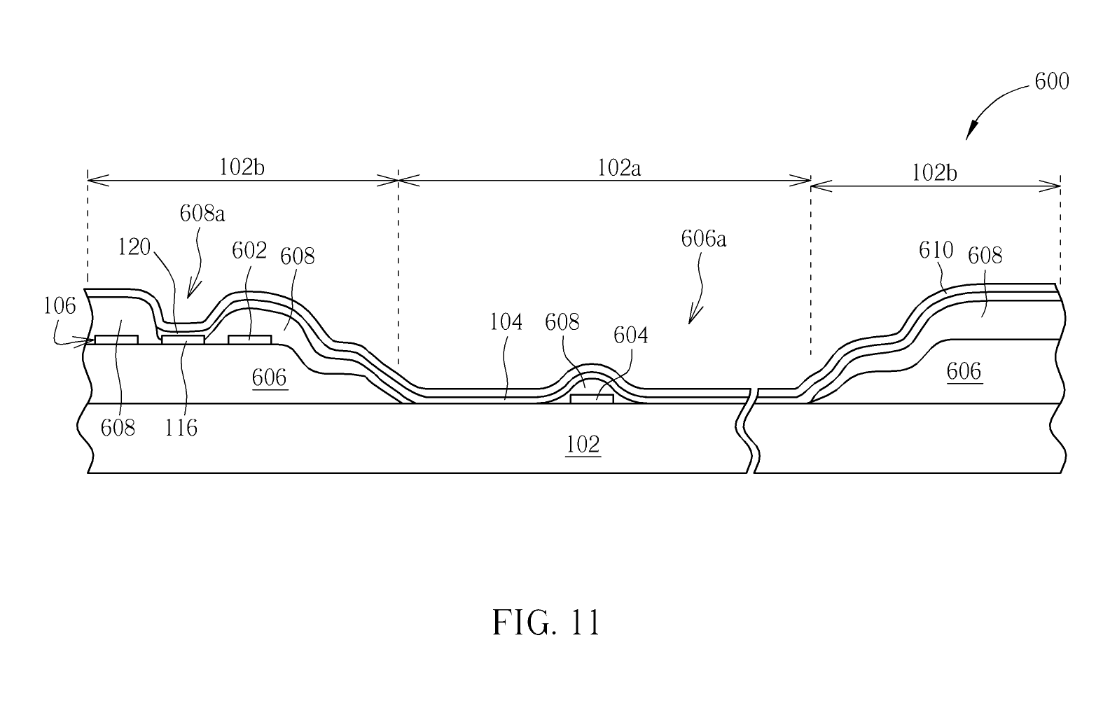

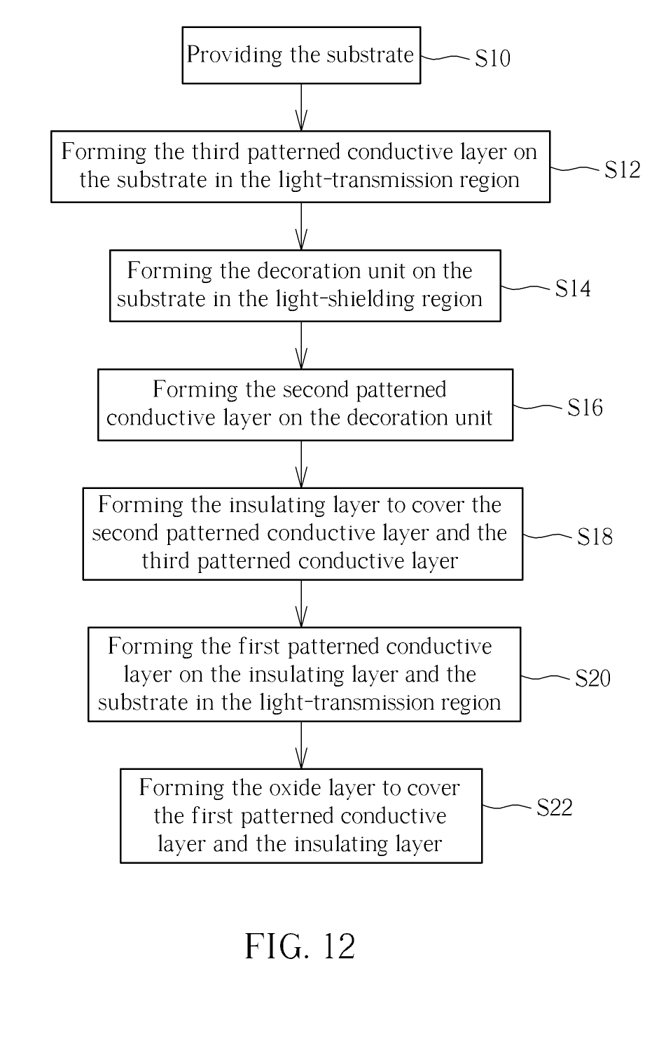

Referring to FIG. 11 and FIG. 12, FIG. 11 is a cross-sectional view of a touch panel according to a seventh embodiment of the present invention, and FIG. 12 is a flow chart of a method for manufacturing the touch panel according to the seventh embodiment of the present invention. The following description takes FIG. 1B as an example. As shown in FIG. 11 and FIG. 12, as compared with the first embodiment, the touch panel 600 in this embodiment is a SITO structure, and the second conductive pattern 106 further includes an inner ground line 602 disposed between the connecting electrodes 116 and the light-transmission region 102a. The inner ground line 602 is electrically connected to a ground potential and insulated from the first conductive pattern 104. In other embodiments of the present invention, the inner ground line may optionally surround the light-transmission region, but the present invention is not limited to this. In addition, the touch panel 600 in this embodiment may optionally further include a third patterned conductive layer 604, a decoration unit 606, an insulating layer 608, and an oxide layer 610. The manufacturing method and structure of the touch panel 600 in this embodiment will be further detailed in the following description. The manufacturing method of the touch panel in this embodiment includes the following steps performed in order:

Step S10: providing the substrate 102;

Step S12: forming the third patterned conductive layer 604 on the substrate 102 in the light-transmission region 102a;

Step S14: forming the decoration unit 606 on the substrate 102 in the light-shielding region 102b;

Step S16: forming the second conductive pattern 106 on the decoration unit 606;

Step S18: forming the insulating layer 608 to cover the second conductive pattern 106 and the third patterned conductive layer 604;

Step S20: forming the first conductive pattern 104 on the insulating layer 608 and the substrate 102 in the light-transmission region 102a; and

Step S22: forming the oxide layer 610 to cover the first conductive pattern 104 and the insulating layer 608.

Between step S10 and step S12, a silicon oxide layer may be optionally formed. In step S12, the third patterned conductive layer 604 is disposed on the substrate 102 in the light-transmission region 102a, and includes a plurality of bridge electrodes (not shown in figures) used to connect the central electrodes 108 and the peripheral electrodes 110 in the same row or in the same column. In step S14, the decoration unit 606 is disposed on the substrate 102 in the light-shielding region 102b and has a first opening 606a exposing the light-transmission region 102a. Furthermore, the decoration unit 606 may include at least one decoration layer, and the decoration layer includes an insulating material with light-shielding function for shielding opaque devices. For example, the insulating material may include a ceramic material, an ink with a color, a photoresist material, diamond like carbon or resin, but the present invention is not limited herein. In other embodiments of the present invention, the decoration unit may be formed before forming the third patterned conductive layer. In step S16, since the second conductive pattern 106 is disposed on the decoration unit 606, the decoration unit 606 may be used to shield the second conductive pattern 106. In step S18, the insulating layer 608 has a second opening 608a exposing the connecting electrodes 116 of the second conductive pattern 106. In step S20, the first conductive pattern 104 extends from the light-transmission region 102a into the second opening 608a through intersecting and spatially separating from the inner ground line 602 so as to be connected to the connecting electrodes 116. Since the insulating layer 608 is disposed between the inner ground line 602 and the first conductive pattern 104, the inner ground line 602 can be electrically insulated from the first conductive pattern 104. In step S22, the oxide layer 610 covers the first conductive pattern 104 and the insulating layer 608, and the oxide layer 610 may include silicon oxide, but the present invention is not limited herein. In the other embodiments of the present invention, the step of forming the second conductive pattern and the step of forming the first conductive pattern may be exchanged. In other words, the first conductive pattern may be formed after forming the decoration unit and the third patterned conductive layer, and then, the insulating layer and the second conductive pattern are formed sequentially. Also, another insulating layer may be optionally formed to cover the oxide layer 610 after forming the oxide layer 610.

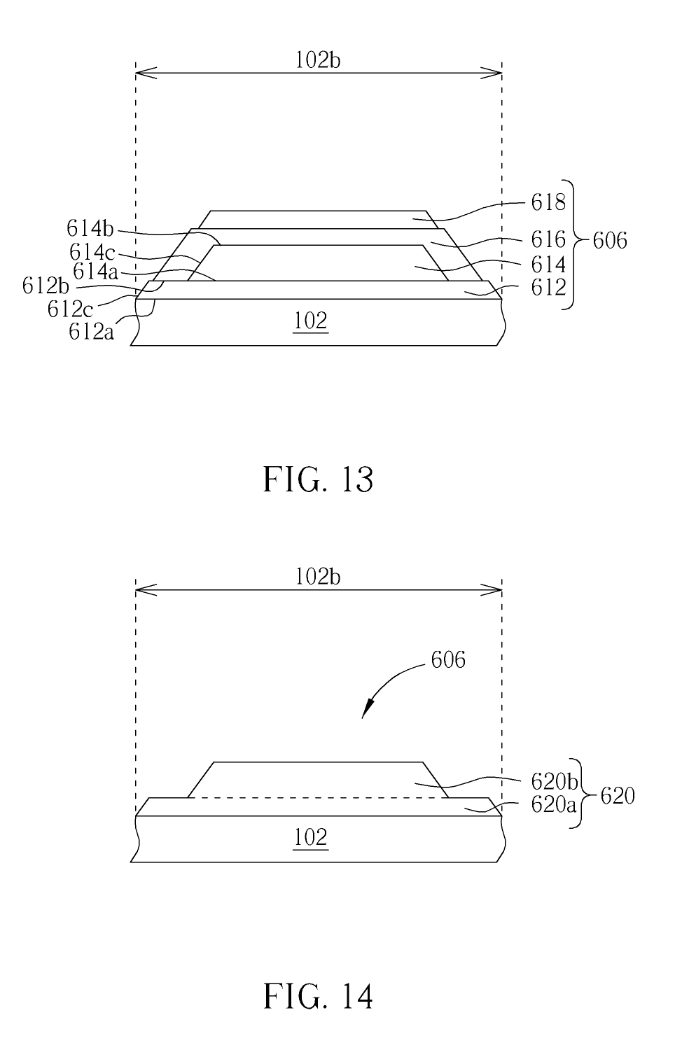

Referring FIG. 13, FIG. 13 is a schematic diagram illustrating the decoration unit according to the seventh embodiment of the present invention. As shown in FIG. 13, the decoration unit 606 may include at least two decoration layers, and materials of the at least two decoration layers may respectively include a ceramic material, an ink with a color, a photoresist material, diamond like carbon, resin or an insulating material composed of at least two thereof. The decoration unit 606 constitutes a step structure so as to avoid an included angle between the sidewall of the decoration unit 606 and the surface of the substrate 102 being over large. Accordingly, the breakage of the first conductive pattern 104 stacked on the decoration unit 606 and the substrate 102 caused by the over large turning angle can be prevented. For example, the decoration unit 606 in this embodiment includes a first decoration layer 612, a second decoration layer 614, a third decoration layer 616, and a light-shielding layer 618, and the first decoration layer 612, the second decoration layer 614, the third decoration layer 616, and the light-shielding layer 618 are sequentially stacked on the substrate 102 in a projection direction perpendicular to the substrate 102. A width of a bottom surface 612a of the first decoration layer 612 along a direction parallel to the substrate 102 is larger than a width of a top surface 612b of the first decoration layer 612 along the direction parallel to the substrate 102, so that the sidewall 612c of the first decoration layer 612 is an inclined surface, and the included angle between the inclined surface and the surface of the substrate 102 is larger than 90 degrees. Similarly, a width of a bottom surface 614a of the second decoration layer 614 disposed on the first decoration layer 612 along the direction parallel to the substrate 102 is smaller than a width of a top surface 612b of the first decoration layer 612 along the direction parallel to the substrate 102 and larger than a width of the top surface 614b of the second decoration layer 614 along the direction parallel to the substrate 102. Accordingly, the sidewall 614c of the second decoration layer 614 may also be an inclined surface, and an included angle between the inclined surface and the top surface 612a of the first decoration layer 612 is larger than 90 degrees. Thus, the sidewall 612c and the top surface 612a of the first decoration layer 612 and the sidewall 614c and the top surface 614b of the second decoration layer 614 constitute a step structure. Furthermore, the third decoration layer 616 covers the top surface 614b and the sidewall 614c of the second decoration layer 614, and the light-shielding layer 618 is disposed on the third decoration layer 616. In other embodiments of the present invention, the step structure may be formed by the decoration unit with other decoration layers. In this embodiment, the first decoration layer, the second decoration layer and the third decoration layer may be white, and the light-shielding layer may be black, but the present invention is not limited to this. In other embodiments of the present invention, the first decoration layer, the second decoration layer, the third decoration layer and the light-shielding layer may have other colors and may be adjusted according to required decoration designs.

Referring to FIG. 14, FIG. 14 is a variant of the decoration unit according to the seventh embodiment of the present invention. As shown in FIG. 14, as compared the above-mentioned seventh embodiment, the decoration unit 606 of this variant is composed of a single decoration layer 620, and the decoration unit 606 has a step structure. The material of the decoration layer 620 may include a ceramic material, an ink with a color, a photoresist material, diamond like carbon, resin or an insulating material composed of at least two thereof. Specifically, the decoration layer 620 includes a bottom part 620a and a top part 620b, and the sidewall of the top part 620b and the top surface of the bottom part 620a are connected to each other. In other words, a width of the bottom part 620a along the direction parallel to the substrate 102 is larger than a width of the top part 620b along the direction parallel to the substrate 102.

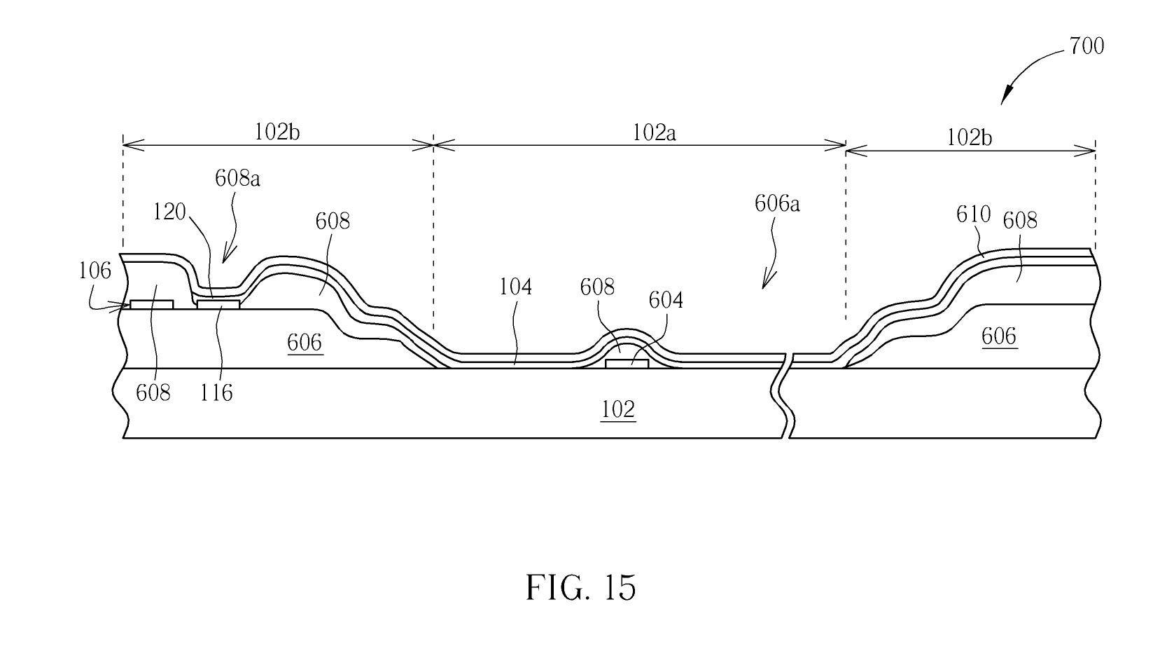

Referring to FIG. 15, FIG. 15 is a schematic diagram illustrating the decoration unit according to the eighth embodiment of the present invention. As shown in FIG. 15, as compared with the seventh embodiment, the touch panel 700 of this embodiment doesn't include the inner ground line, and the decoration unit 606 of this embodiment may have the step structure. For example, the decoration unit 606 also includes at least two decoration layers that are first decoration layer 612 and the second decoration layer 614, and the first decoration layer 612 and the second decoration layer 614 of the decoration unit 606 form the step structure, as shown in FIG. 13. Or, the decoration unit 606 of this embodiment may include only one decoration layer 620, and the decoration layer 620 has the step structure, as shown in FIG. 14.

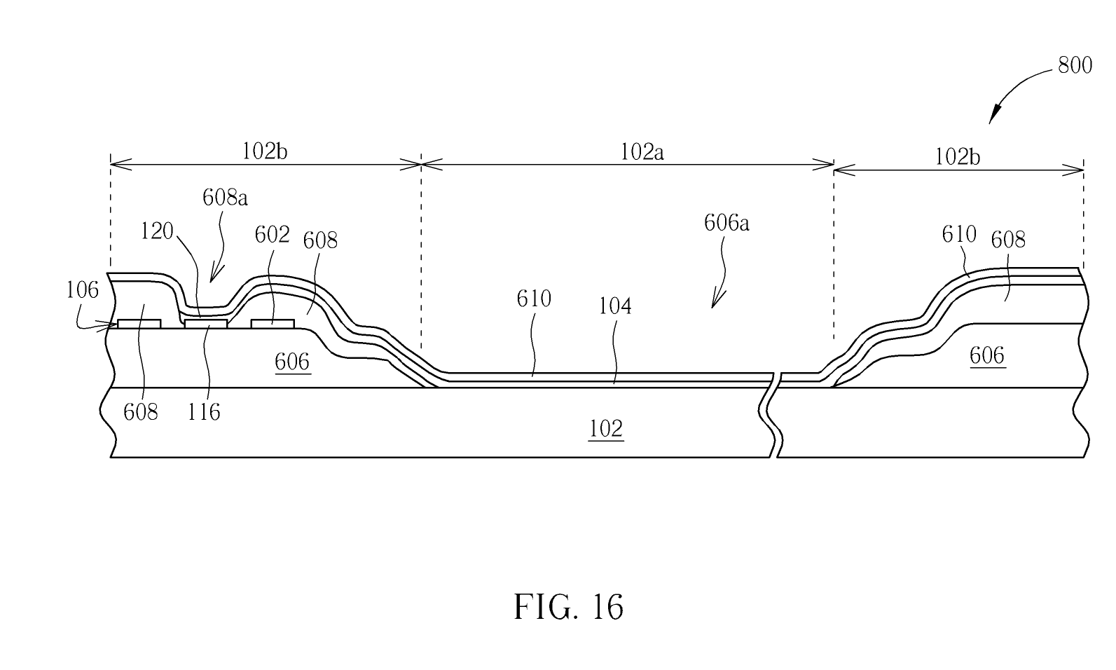

The first conductive pattern in the light-transmission region of the present invention is not limited to be the double layer electrode as shown in FIGS. 1A, 1B, 11 and 15, and also may be a design of a pattern of one layer electrode. Referring FIG. 16, FIG. 16 is a cross-sectional view of a touch panel according to a ninth embodiment of the present invention. As shown in FIG. 16, as compared with the seventh embodiment, the touch panel 800 of this embodiment may be a design of one layer electrode. The touch panel 800 only includes the single-layer first conductive pattern 104, but doesn't include the third patterned conductive layer and the insulating layer. In other embodiments of the present invention, the touch panel of the eighth embodiment may use the design of the one-layer electrode pattern.

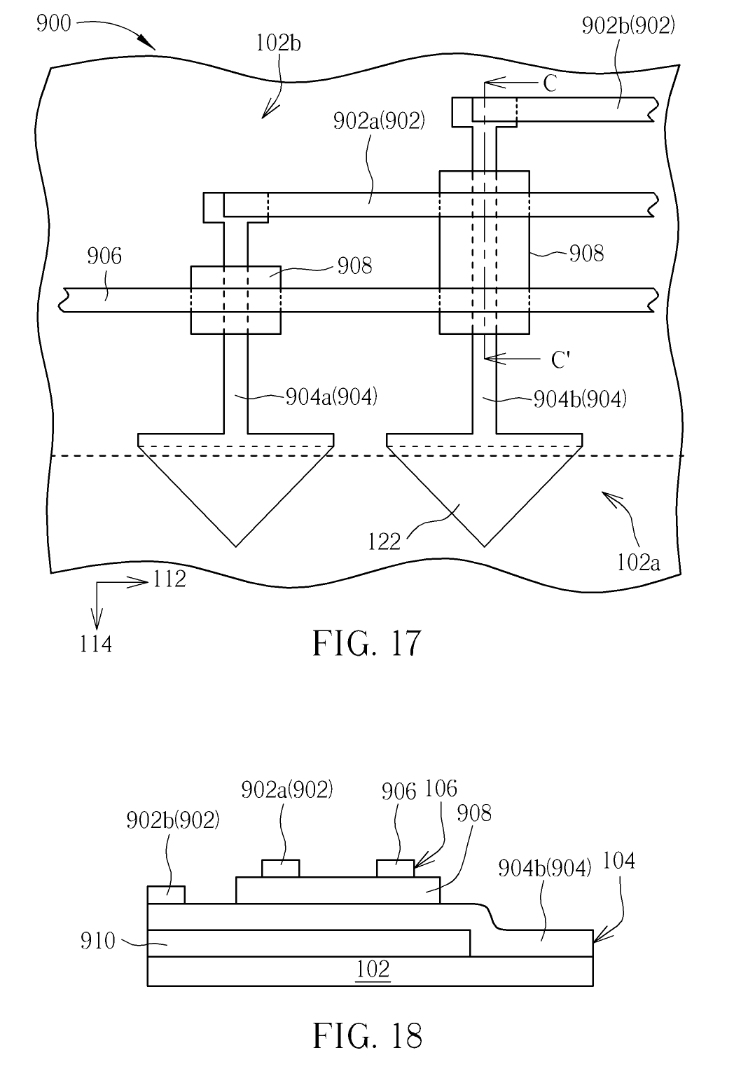

Referring to FIG. 17 and FIG. 18, FIG. 17 is a top view of a touch panel according to a tenth embodiment of the present invention, and FIG. 18 is a cross-sectional view of FIG. 17 along a cross-sectional line C-C′. As shown in FIG. 17 and FIG. 18, as compared with the first embodiment, each connecting part 904 of the touch panel 900 of this embodiment extends along the direction perpendicular to the light-transmission region 102a to be electrically connected to the corresponding connecting line 902 instead of bending to be perpendicular to the side of the light-transmission region 102a. Also, the second conductive pattern 106 further include an inner ground line 906 disposed between the connecting lines 902 and the light-transmission region 102a, and the inner ground line 906 and the connecting lines 902 are arranged sequentially from a near side close to the side of the light-transmission region 102a to a far side away from the side of the light-transmission region 102a. The connecting lines 902 arranged sequentially from the inside to the outside are electrically connected to the connecting parts 904 arranged sequentially from the left to the right respectively, and extend toward the right. Accordingly, one of the connecting parts 904 intersects and spatially insulates from the inner ground line 906 and at least one of the connecting lines 902 disposed between another one of the connecting lines 902 corresponding to the one of the connecting parts 904 and the inner ground line 906. The at least one of the connecting lines 902 intersects but is not electrically connected to the one of the connecting parts 904. Specifically, please see the dash line connected between two ends P of each electrode part 122, and each connecting part 904 extends from the dash line. Each connecting part 904 intersects and spatially insulates from the inner ground line 906 and is connected to each connecting line 902, and except the leftest connecting part 904, other connecting parts 904 intersect and spatially insulate from at least one of the connecting lines 902 disposed between the connecting line 902 electrically connected to the corresponding connecting part 904 and the inner ground line 906. In order to electrically insulating the connecting parts 904 from the connecting lines 902 without being electrically connected thereto and the inner ground line 906, the touch panel 900 further includes an insulating layer 908 disposed between each connecting part 904 and at least one of the connecting lines 902 disposed between one of the connecting lines 902 electrically connected to this connecting part 904 and the inner ground line 906 and between each connecting part 904 and the inner ground line 906. For example, the connecting lines 902 includes a first connecting line 902a and a second connecting line 902b, and the connecting parts 904 includes a first connecting part 904a and the second connecting part 904b. The first connecting part 904a and the second connecting part 904b extend onto the decoration unit 910 along the second direction 114. The insulating layer 908 is disposed on the first connecting part 904a and the second connecting part 904b. The first connecting line 902a intersects and spatially insulates from the second connecting part 904b and extends onto the first connecting part 904a along the first direction 112 so as to be in contact with the first connecting part 904a. The insulating layer 908 is disposed at the crossing of the first connecting line 902a and the second connecting part 904b and between the first connecting line 902a and the second connecting part 904b so as to electrically insulate the first connecting line 902a from the second connecting part 904b. The second connecting line 902b extends onto the second connecting part 904b along the first direction 112 so as to be in contact with the second connecting part 904b. The inner ground line 906 extends along the first direction 112 and intersects and spatially insulates from the first connecting part 904a and the second connecting part 904b. The insulating layer 908 is disposed at the crossing of the inner ground line 906 and the first connecting part 904a and at the cross of the inner ground line 906 and the second connecting part 904b, and is located between the inner ground line 906 and the first connecting part 904a and between the inner ground line 906 and the second connecting part 904b so as to electrically insulate the inner ground line 906 from the first connecting part 904a and the second connecting part 904b.

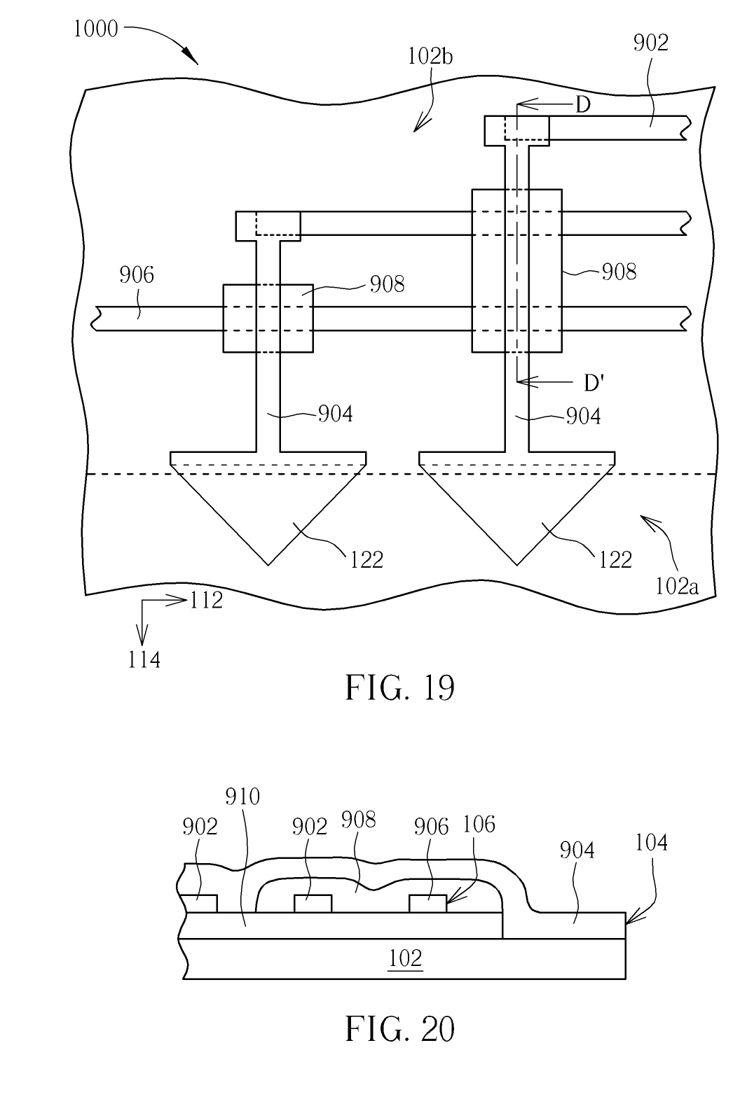

Referring to FIG. 19 and FIG. 20, FIG. 19 is a top view of a touch panel according to an eleventh embodiment of the present invention, and FIG. 20 is a cross-sectional view of FIG. 19 along a cross-sectional line D-D′. As shown in FIG. 19 and FIG. 20, as compared with the tenth embodiment, the second conductive pattern 106 of the touch panel 1000 in this embodiment is disposed between the first conductive pattern 104 and the substrate 102. Specifically, the connecting lines 902 and the inner ground line 906 are disposed between the connecting parts 904 and the decoration unit 910. Furthermore, the insulating layer 908 is disposed at the crossings of each connecting line 902 and the connecting parts 904 without being electrically connected thereto and at the crossing of each connecting line 902 and the inner ground line 906 and is disposed between each connecting line 902 and the connecting parts 904 without being electrically connected thereto and between each connecting line 902 and the inner ground line 906 so as to electrically insulate each connecting line 902 from the connecting parts 904 without being electrically connected thereto and the inner ground line 906.

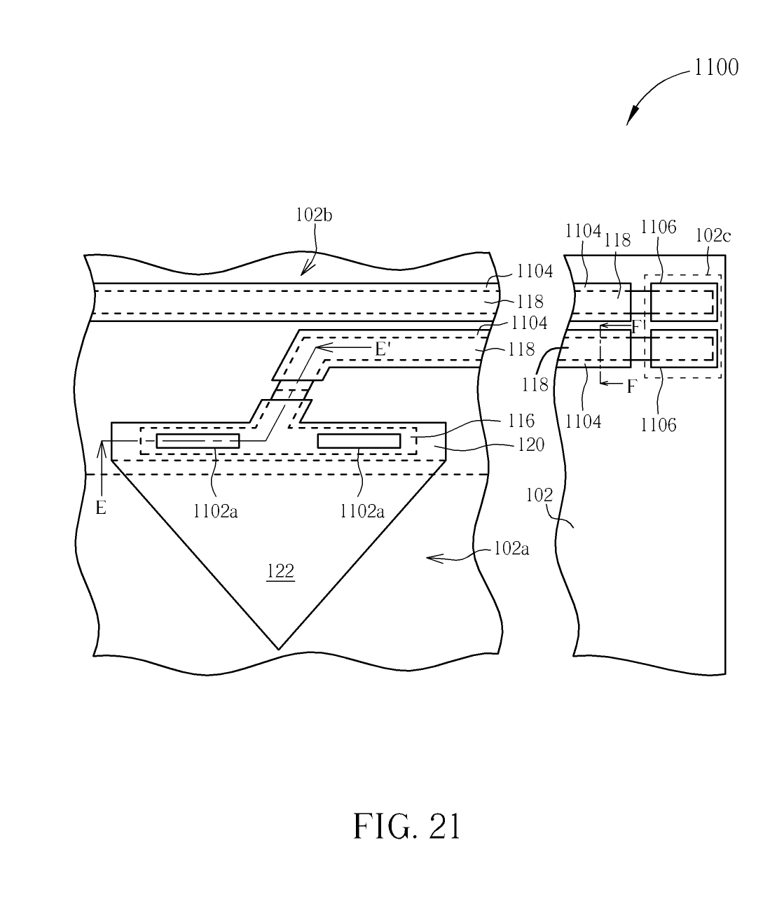

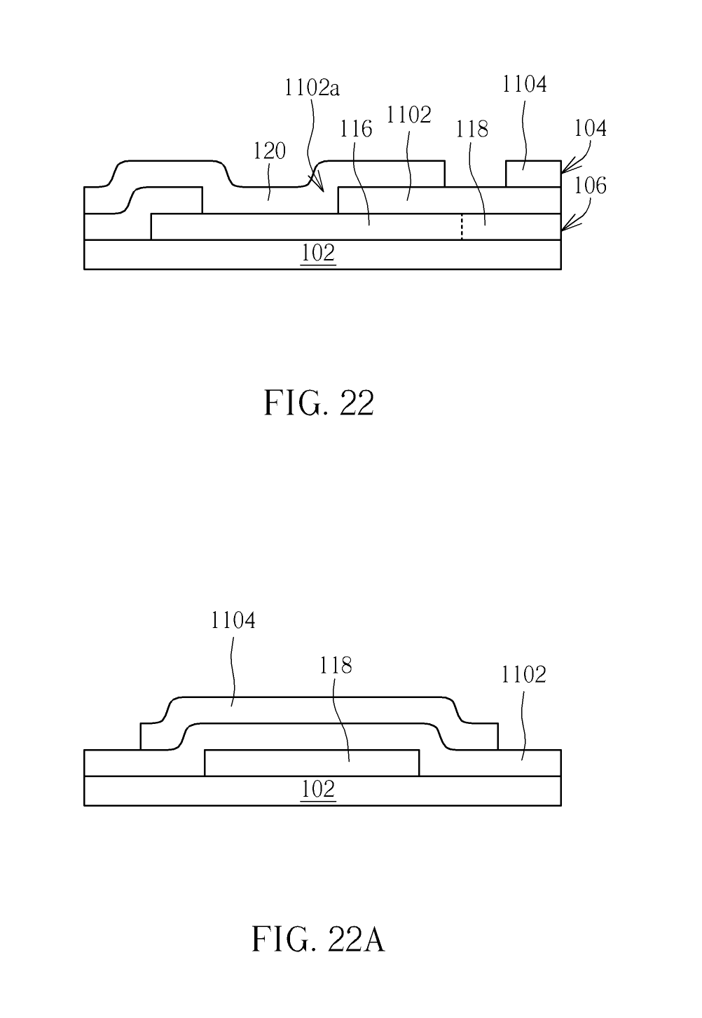

Referring to FIG. 21, FIG. 22 and FIG. 22A, FIG. 21 is a top view of a touch panel according to a twelfth embodiment of the present invention, FIG. 22 is a cross-sectional view of FIG. 21 along a cross-sectional line E-E′, and FIG. 22A is a cross-sectional view of FIG. 21 along a cross-sectional line F-F′. As shown in FIG. 21, FIG. 22 and FIG. 22A, as compared with first embodiment, a part of the second conductive pattern 106 of the touch panel 1100 in this embodiment is disposed between a part of the first conductive pattern 104 corresponding to the part of the second conductive pattern 106 and the substrate 102. The touch panel 1100 further includes an insulating layer 1102 disposed between the first conductive pattern 104 and the second conductive pattern 106. The insulating layer 1102 has at least one through hole 1102a disposed at an overlapping area of each connecting electrode 116 and each connecting part 120, so that each connecting part 120 may be electrically connected to each connecting electrode 116 through the through hole 1102a. It should be noted that the first conductive pattern 104 further includes a plurality of protection lines 1104 in this embodiment. A width of each protection line 1104 is larger than a width of each connecting line 118, and each protection line 1104 covers and shields each connecting line 118 in the projection direction perpendicular to the substrate 102. Hence, during forming the first conductive pattern 104, an etching solution, such as aqua regia, for etching the first conductive pattern 104 can be stopped by the protection lines 1104 and doesn't easily etch through the insulating layer 1104 and damage the connecting lines 118. Accordingly, the breakage of the connecting lines 118 can be avoided. Besides, the protection lines 1104 are disconnected from one another and the connecting parts 120, so that the protection lines 1104 are electrically disconnected from the connecting parts 120. The substrate 102 has a connecting pad region 102c disposed in the light-shielding region 102b. Each connecting line 118 extends from an end connected to each connecting electrode 116 into the connecting pad region 102c of the substrate 102. The connecting pad region 102c may be used to dispose a flexible circuit board, and each connecting line 118 can be electrically connected to the flexible circuit board in the connecting pad region 102c so as to be electrically connected to the outside control device through the flexible circuit board. Furthermore, the first conductive pattern 104 further includes a plurality of protection electrodes 1106 disposed on the connecting lines 118 in the connecting pad region 102c respectively and electrically connected to the connecting lines 118 respectively. A width of each protection electrode 1106 is larger than a width of each connecting line 118, and accordingly, each protection electrode 1106 may cover and shield each connecting line 118 in the projection direction perpendicular to the substrate 102 so as to protect each connecting line 118 from being etched by the etching solution. Also, the protection lines 1104, the connecting part 120 and the protection electrode 1106 are disconnected from one another, which are electrically disconnected from one another, so a load capacitance of each connecting line 118 would not be affected by the protection lines 1104 and can be reduced effectively, In other embodiments of the present invention, the protection electrodes may be optionally neglected. Here, the electrode part 122, connecting part 120, and the protection lines 1104 can be formed by the same process step and made from the same material, such as indium tin oxide (ITO) or indium zinc oxide (IZO).

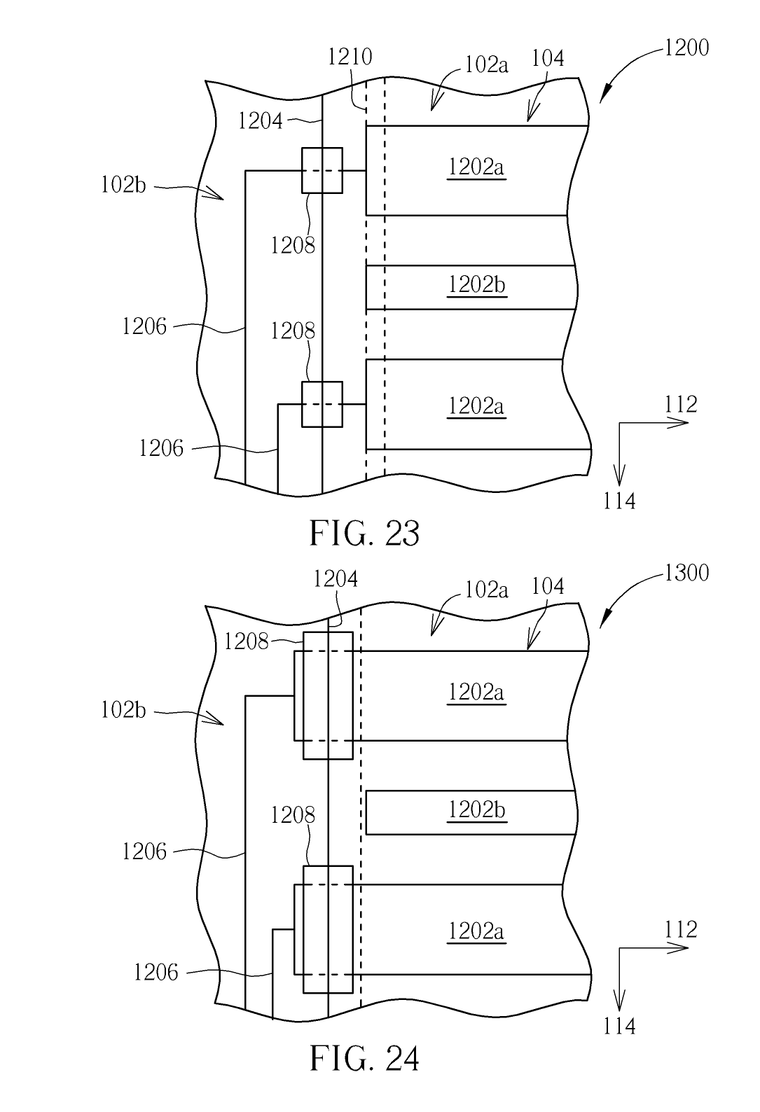

The first conductive pattern and the inner ground line of the touch panel of the present invention may be different from the above-mentioned embodiments. Referring to FIG. 23, FIG. 23 is a schematic diagram illustrating a touch panel according to a thirteenth embodiment of the present invention. As shown in FIG. 23, as compared with the first embodiment, the first conductive pattern 104 of the touch panel 1200 in this embodiment includes a plurality of first electrodes 1202a and a plurality of second electrodes 1202b. Each first electrode 1202a is used to receive a driving signal, and each second electrode 1202b is used to transmit a sensing signal back to a control device so as to judge the position of the object. Each first electrode 1202a and each second electrode 1202b are arranged alternately along the second direction 114, and one edge of each first electrode 1202a facing the light-shielding region 102b disposed at a side of the substrate 102 and one edge of each second electrode 1202b facing the light-shielding region 102b disposed at the side of the substrate 102 are substantially aligned in the second direction 114. Specifically, they are aligned to a same alignment line 1210. Furthermore, the touch panel 1200 further includes an inner ground line 1204 disposed between the connecting lines 1206 extending along the second direction 114 and the second electrodes 1202b so as to shield the connecting lines 1206 for transmitting the driving signals from the second electrodes 1202b for transmitting the sensing signals and to avoid the driving signals disturbing the sensing signals sensed by the second electrodes 1202b. Also, the touch panel 1200 in this embodiment further includes an insulating layer 1208 disposed between the inner ground line 1204 and the connecting lines 1206 and used for electrically insulating the inner ground line 1204 from the connecting lines 1206. In other embodiments of the present invention, the insulating layer disposed between different connecting lines and the inner ground line may be connected to one another. In this embodiment, the width of the inner ground line 1204 and the width of each connecting line are not limited to be shown in FIG. 23, and can be adjusted according to the requirements. Preferably, a width of the inner ground line 1204 is larger than and equal to a width of each connecting line 1206.

Referring to FIG. 24, FIG. 24 is a schematic diagram illustrating a touch panel according to a fourteenth embodiment of the present invention. As shown in FIG. 24, as compared with the thirteenth embodiment, in the touch panel 1300 of this embodiment, the edge of each first electrode 1202a facing the light-shielding region 102b disposed at the side of the substrate 102 is not aligned to the edge of each second electrode 1202b facing the light-shielding region 102b disposed at the side of the substrate 102, so that the edge of each first electrode 1202a facing the light-shielding region 102b disposed at the side of the substrate 102 and the edge of each second electrode 1202b facing the light-shielding region 102b disposed at the side of the substrate 102 are not aligned in the second direction 114. Specifically, each first electrode 1202a extends into the light-shielding region 102b. But, each second electrode 1202b doesn't extend into the light-shielding region 102b. Also, the inner ground line 1204 in this embodiment extends along the second direction 114 and intersects and spatially insulates from the first electrodes 1202a, but the inner ground line 1204 does not intersect the second electrodes 1202b. In other words, the inner ground line 1204 is disposed the connecting lines 1206 extending along the second direction 114 and the second electrodes 1202b and used to shield the connecting lines 1206 for transmitting the signal signals from the second electrodes 1202b for transmitting the sensing signals and to avoid the driving signals disturbing the sensing signals sensed by the second electrodes 1202b. Furthermore, the insulating layer 1208 of the touch panel 1300 in this embodiment is disposed between the inner ground line 1204 and the first electrodes 1202a and used to electrically insulate the inner ground line 1204 from the first electrodes 1202a. In other embodiments of the present invention, the insulating layer disposed between different connecting lines and the inner ground line may be connected to one another. In this embodiment, the width of the inner ground line 1204 and the width of each connecting line are not limited to be shown in FIG. 24, and can be adjusted according to the requirements. Preferably, a width of the inner ground line 1204 is larger than and equal to a width of each connecting line 1206.

To be summarized, in the touch panel of the present invention, since the ends of each electrode part are disposed between the first sides of each connecting part or disposed at the same level as each first side, the second sides of each connecting electrode are disposed between the first sides of each connecting part, and the distance between each connecting electrode and the connecting part near this connecting electrode can be increased. Accordingly, a short circuit between each connecting electrode and the connecting electrode near this connecting electrode caused from the inaccuracy in the manufacturing process can be avoided. Furthermore, in the touch panel of the present invention, since the first sides of each connecting part are disposed between the ends of each electrode part, the first sides of each connecting part are disposed between the second sides of each connecting electrode, thereby avoiding the electrostatic charges damaging the central electrodes and the peripheral electrodes. Also, each connecting electrode extends onto the substrate from each connecting part, so that each connecting line can be connected to a part of each connecting electrode without overlapping each connecting part. Accordingly, the breakage of the connection between each connecting line and each connecting electrode can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate having a light-shielding region and a light-transmission region;
a first conductive pattern disposed on the substrate, the first conductive pattern comprising a plurality of peripheral electrodes, and at least one part of each peripheral electrode extending from the light-transmission region into the light-shielding region, each peripheral electrode comprising a connecting part, wherein each connecting part has two first sides opposite to each other, and the first sides of each connecting part are spaced apart a first distance; and
a second conductive pattern, at least a part of the second conductive pattern being disposed on the substrate in the light-shielding region, the second conductive pattern comprising a plurality of connecting electrodes, and each connecting electrode partially overlapping and being electrically connected to each corresponding connecting part, wherein each connecting electrode has two second sides opposite to each other, the second sides of each connecting electrode are spaced apart a second distance, and the second distance is smaller than the first distance.

2. The touch panel according to claim 1, wherein the second conductive pattern further comprises a plurality of connecting lines, each connecting line is connected to a part of each connecting electrode without overlapping each connecting part.

3. The touch panel according to claim 2, wherein the second conductive pattern further comprises an inner ground line disposed between the connecting electrodes of the second conductive pattern and the light-transmission region.

4. The touch panel according to claim 3, wherein one of the connecting parts intersects and spatially insulates from the inner ground line and at least one of the connecting lines disposed between another one of the connecting lines corresponding to the one of the connecting parts and the inner ground line.

5. The touch panel according to claim 4, further comprising an insulation layer disposed between the one of the connecting parts and the inner ground line or between the one of the connecting parts and the at least one of the connecting lines.

6. The touch panel according to claim. 2, wherein a part of the second conductive pattern is disposed between a part of the first conductive pattern corresponding to the part of the second conductive pattern and the substrate, wherein the first conductive pattern further comprises a plurality of protection lines, and each protection line shields each connecting line in a projection direction perpendicular to the substrate, wherein a width of each protection line is larger than a width of each connecting line.

7. The touch panel according to claim 6, wherein each connecting line extends into a connecting pad region of the substrate, and the first conductive pattern further comprises a plurality of protection electrodes, wherein each protection electrode is disposed on each connecting line in the connecting pad region respectively, and the protection lines, the connecting parts and the protection electrodes are disconnected from one another.

8. The touch panel according to claim 2, wherein the first conductive pattern comprises a plurality of first electrodes and a plurality of second electrodes, and each first electrode and each second electrode are arranged alternately in sequence along a direction, wherein the second conductive pattern further comprises an inner ground line disposed between the connecting lines extending along the direction and the second electrodes.

9. The touch panel according to claim 8, wherein one edge of each first electrode facing the light-shielding region disposed at a side of the substrate and one edge of each second electrode facing the light-shielding region disposed at the side of the substrate are aligned in the direction.

10. The touch panel according to claim 8, wherein one edge of each first electrode facing the light-shielding region disposed at a side of the substrate and one edge of each second electrode facing the light-shielding region disposed at the side of the substrate are not aligned in the direction, and the inner ground line intersects and spatially insulates from the first electrodes but does not intersect the second electrodes.

11. The touch panel according to claim 1, wherein the first conductive pattern comprises carbon nanotubes, metal nanowires, conducting polymers, grapheme or silicene.

12. The touch panel according to claim 1, wherein each connecting electrode comprises a plurality of holes.

13. The touch panel according to claim 1, further comprising a decoration unit disposed between the second conductive pattern and the substrate.

14. The touch panel according to claim 13, wherein the decoration unit comprises at least two decoration layers, the at least two decoration layers constitutes a step structure, and materials of the at least two decoration layers respectively comprise a ceramic material, an ink with a color, a photoresist material, diamond like carbon, resin or an insulating material composed of at least two thereof.

15. The touch panel according to claim 13, wherein the decoration unit comprises a decoration layer, and the decoration layer has a step structure.

16. A touch panel, comprising:
a substrate having a light-shielding region and a light-transmission region;
a first conductive pattern disposed on the substrate, the first conductive pattern comprising a plurality of peripheral electrodes, and at least a part of the peripheral electrodes extending from the light-transmission region into the light-shielding region, each peripheral electrode comprising a connecting part, wherein each connecting part has two first sides opposite to each other, and the first sides of each connecting part are spaced apart a first distance; and
a second conductive pattern, at least a part of the second conductive pattern being disposed on the substrate in the light-shielding region, the second conductive pattern comprising a plurality of connecting electrodes, and each connecting electrode partially overlapping and being electrically connected to each connecting part, wherein each connecting electrode has two second sides opposite to each other, the second sides of each connecting electrode are spaced apart a second distance larger than or equal to the first distance.

17. The touch panel according to claim 16, wherein each peripheral electrode further comprises an electrode part, each electrode part has two ends, and the ends of each electrode part are spaced apart a second largest width, larger than the first distance and the second distance.

18. The touch panel according to claim 16, wherein the second conductive pattern further comprises a plurality of connecting lines, each connecting line is connected to a part of each connecting electrode without overlapping each connecting part.

19. The touch panel according to claim 18, wherein the second conductive pattern further comprises an inner ground line disposed between the connecting electrodes and the light-transmission region.

20. The touch panel according to claim 19, wherein one of the connecting parts intersects and spatially insulates from the inner ground line and at least one of the connecting lines disposed between another one of the connecting lines corresponding to the one of the connecting parts and the inner ground line.

21. The touch panel according to claim 20, further comprising an insulation layer disposed between the one of the connecting parts and the inner ground line or between the one of the connecting parts and the at least one of the connecting lines.

22. The touch panel according to claim 18, wherein a part of the second conductive pattern is disposed between a part of the first conductive pattern corresponding to the part of the second conductive pattern and the substrate, wherein the first conductive pattern further comprises a plurality of protection lines, and each protection line shields each connecting line in a projection direction perpendicular to the substrate, wherein a width of each protection line is larger than a width of each connecting line.

23. The touch panel according to claim 22, wherein each connecting line extends into a connecting pad region of the substrate, wherein the first conductive pattern further comprises a plurality of protection electrodes, and each protection electrode is disposed on each connecting line in the connecting pad region respectively, and the protection lines, the connecting parts and the protection electrodes are disconnected from one another.

24. The touch panel according to claim 18, wherein the first conductive pattern comprises a plurality of first electrodes and a plurality of second electrodes, and each first electrode and each second electrode are arranged alternately along a direction, wherein the second conductive pattern further comprises an inner ground line disposed between the connecting lines extending along the direction and the second electrodes.

25. The touch panel according to claim 24, wherein one edge of each first electrode facing the light-shielding region disposed at a side of the substrate and one edge of each second electrode facing the light-shielding region disposed at the side of the substrate are aligned in the direction.

26. The touch panel according to claim 24, wherein one edge of each first electrode facing the light-shielding region disposed at a side of the substrate and one edge of each second electrode facing the light-shielding region disposed at the side of the substrate are not aligned in the direction, and the inner ground line intersects and spatially insulates from the first electrodes but does not intersect the second electrodes.

27. The touch panel according to claim 16, wherein the first conductive pattern comprises carbon nanotubes, metal nanowires, conducting polymers, grapheme or silicene.

28. The touch panel according to claim 16, wherein each connecting electrode comprises a plurality of holes.

29. The touch panel according to claim 16, further comprising a decoration unit disposed between the second conductive pattern and the substrate.

30. The touch panel according to claim 29, wherein the decoration unit comprises at least two decoration layers, the at least two decoration layers constitutes a step structure.

31. The touch panel according to claim 29, wherein the decoration unit comprises a decoration layer, and the decoration layer has a step structure.
